(19) United States
(12) Patent Application Publication
(10) Pub. No.: US 2007/0192700 A1
(43) Pub. Date: Aug. 16, 2007

(54) Support of remote software applications

(75) Inventor: Vibhuti Singh Sengar, Unnao (IN)

Correspondence Address: Frederick W. Gibb, III;McGinn & Gibb, PLLC, Suite 304, 2568-A Riva Road, Annapolis, MD, 21401, US

(73) Assignee: International Business Machines Corporation, Armonk, NY (US)

(21) Appl. No.: 11/292,096

(22) Filed: Nov. 29, 2005

(51) Int. Cl. G06F 3/00; G06F 15/173; H04L 12/58; H04M 1/24

(52) U.S. Cl. 715/733; 709/224; 455/412.1; 379/1.01

(57) ABSTRACT

GUI log text record arrangements (referred to as GLTR arrangements) are disclosed which facilitate the problem diagnosis process between a Support Service Provider (SSP) machine (101) and a client machine (108). Graphical User Interface (GUI) screens and their associated user actions, with reference to a client application, are logged on the client machine (108) in the form of GUI log text records. The SSP machine (101) reproduces the application GUI screens and the user actions from logged GUI log text records passed from the client machine (108). This provides, to the SSP machine (101), a facility for browsing through historic application GUI screens and their associated user actions. The GLTR system also provides a facility for remotely operating the client application, to further clarify the problem, and/or to take remedial action for overcoming the problem.

### FIELD OF THE INVENTION

The present invention relates generally to providing technical support to client applications running on machines remote from the service support facility, and in particular, to automatic or semi-automatic support techniques.

### BACKGROUND

As a result of the increase in complexity of business software applications and their cost of ownership, enterprises are increasingly becoming aware of the need for remotely supporting applications running on the “client side”. The current methods for supporting an application on the client side are labour intensive, and this results in increased problem diagnosis time, and consequently, increased cost of ownership.

### SUMMARY

it is an object of the present invention to substantially overcome, or at least ameliorate, one or more disadvantages of existing arrangements.

Disclosed are arrangements, referred to as GUI log text record arrangements, which seek to address the above problems by facilitating the problem diagnosis process between the Support Service Provider (SSP) and the client. Although the terminology of “problem” and “problem solution” are used in the description, it is noted that the user may invoke the disclosed GUI log text record arrangement (also referred to as a GLTR arrangement) merely to obtain assistance even if there is no “problem” or “fault” as such. The description should be read in this light. This GLTR approach typically decreases the application problem diagnosis time by a significant amount. Graphical User Interface (GUI) screens and their associated user actions with reference to an application are logged in form of GUI log text records. The GLTR system reproduces, either exactly or to a high degree of correspondence, the application GUI screens and the user actions, from logged GUI log text records. In some cases the simulated GUI screens may not be exactly the same as historic client GUI screens. The disclosed system is capable in most cases, however, of reproducing at least part of application GUI using components (i.e children of java.awt.component). This provides, to the SSP, a facility for browsing through historic application GUI screens and their associated user actions. The GLTR system also provides a facility for remotely operating the client application, to further clarify the problem, and/or to take remedial action for overcoming the problem.

The disclosed GLTR arrangements perform logging of GUI screens and events in form of compact GUI log text records, and thus network and logging overheads are minimal. For example, GUI screens are logged in the form of GUI log text records and not images. The images (i.e gif, jpg) used in components (i.e icons and buttons) are logged as images, however the screens in which the aforementioned components are displayed are logged using GUI log text records. Furthermore, once the client application in question initiates the logging service (see 405 in FIG. 5) the disclosed GLTR arrangements do not require any support from the client application in question.

According to a first aspect of the present invention, there is provided a method of providing support for a client software application running on a first machine, said method comprising the steps of:
recording at the first machine Graphical User Interface displays and associated user actions as text-based log records;
invoking at a second machine support services dependent upon a support request relating to the running of the client software application on said first machine;
sending the recorded log text records to the second machine; and
simulating at the second machine the Graphical User Interface displays and the associated user actions from the recorded log text records; wherein
said support is provided depending upon the simulation.

According to another aspect of the present invention, there is provided an apparatus for providing support for a client software application running on a first machine, said apparatus comprising:
a memory for storing a program; and
a processor for executing the program, said program comprising:
code for recording at the first machine Graphical User Interface displays and associated user actions as text-based log records;
code for invoking at a second machine support services dependent upon a support request relating to the running of the client software application on said first machine;
code for sending the recorded log text records to the second machine; and
code for simulating at the second machine the Graphical User Interface displays and the associated user actions from the recorded log text records; wherein
said support is provided depending upon the simulation.

According to another aspect of the present invention, there is provided an apparatus for providing support for a client software application running on a first machine, said apparatus comprising:
means for recording at the first machine Graphical User Interface displays and associated user actions as text based log records;
means for invoking at a second machine support services dependent upon a support request relating to the running of the client software application on said first machine;
means for sending the recorded log text records to the second machine; and
means for simulating at the second machine the Graphical User Interface displays and the associated user actions from the recorded log text records; wherein
said support is provided depending upon the simulation.

According to another aspect of the present invention, there is provided a computer program product including a computer readable medium having recorded thereon a computer program for directing a processor to execute a method for providing support for a client software application running on a first machine, said program comprising:
code for recording at the first machine Graphical User Interface displays and associated user actions as text based log records;
code for invoking at a second machine support services dependent upon a support request relating to the running of the client software application on said first machine;
code for sending the recorded log text records to the second machine; and
code for simulating at the second machine the Graphical User Interface displays and the associated user actions from the recorded log text records; wherein
said support is provided depending upon the simulation.

Other aspects of the invention are also disclosed.

### BRIEF DESCRIPTION OF THE DRAWINGS

Some aspects of the prior art and one or more embodiments of the present invention will now be described with reference to the drawings, in which:

FIG. 1 shows a functional block diagram of a computer system in which the disclosed GLTR approach can be practiced;

FIG. 2 shows a general purpose computer arrangement upon which the disclosed GLTR approach can be practiced;

FIG. 3 shows a prior art remote support process that can be practiced on the system of FIG. 1;

FIG. 4 shows an arrangement according to which the disclosed GLTR approach can be practiced on the system of FIG. 1;

FIG. 5 shows a functional block diagram of a system 400 for implementing the disclosed GLTR approach;

FIGS. 6A and 6B show a process that depicts normal operation of the client application;

FIG. 7 shows a process flow/data flow diagram by which the Service Support Application of FIG. 1 operates;

FIG. 8 shows a process according to which the GUI Logging service is initialised in FIGS. 6A and 6B;

FIG. 9 shows one thread of the GUI Logging Service process;

FIG. 10 shows another thread of the GUI Logging Service process;

FIG. 11 shows the step 802 from FIG. 9 in more detail;

FIG. 12 shows the step 803 from FIG. 9 in more detail;

FIGS. 13A and 13B show the step 610 from FIG. 7 in more detail;

FIG. 14 shows the step 605 from FIG. 7 in more detail; and

FIG. 15 shows the step 615 from FIG. 7 in more detail.

### DETAILED DESCRIPTION

Where reference is made in any one or more of the accompanying drawings to steps and/or features, which have the same reference numerals, those steps and/or features have for the purposes of this description the same function(s) or operation(s), unless the contrary intention appears.

Some portions of the description that follows are explicitly or implicitly presented in terms of algorithms and symbolic representations of operations on data within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that the above and similar terms are to be associated with the appropriate physical quantities and are merely convenient labels applied to these quantities. Unless specifically stated otherwise, and as apparent from the following, it will be appreciated that throughout the present specification, discussions utilizing terms such as “scanning”, “calculating”, “determining”, “replacing”, “generating” “initializing”, “outputting”, or the like, refer to the action and processes of a computer system, or similar electronic device, that manipulates and transforms data represented as physical (electronic) quantities within the registers and memories of the computer system into other data similarly represented as physical quantities within the computer system memories or registers or other such information storage, transmission or display devices.

The present specification also discloses apparatus for performing the operations of the GLTR methods. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required GLTR method steps may be appropriate. The structure of a conventional general purpose computer will appear from the description below.

In addition, the present invention also implicitly discloses a computer program, in that it would be apparent to the person skilled in the art that the individual steps of the preferred method described herein are to be put into effect by computer code. The computer program is not intended to be limited to any particular programming language and implementation thereof, even though the description has been presented using the Java language. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing the spirit or scope of the invention. Furthermore one or more of the steps of the computer program may be performed in parallel rather than sequentially.

Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM mobile telephone system. The computer program when loaded and executed on such a general-purpose computer effectively results in an apparatus that implements the steps of the preferred GLTR method.

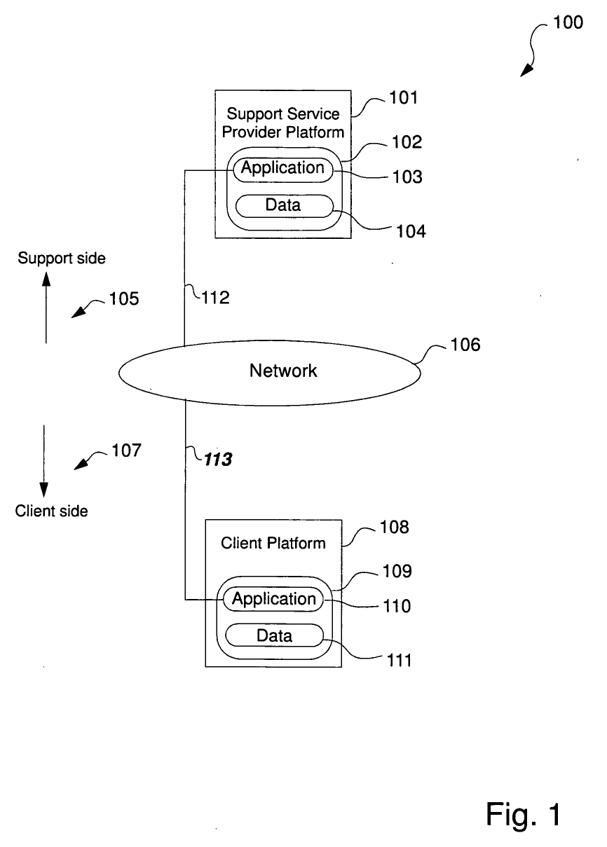

FIG. 1 shows a functional block diagram of a computer system 100 in which the disclosed GLTR approach can be practiced. A client platform machine 108 has a memory 109 storing a client application 110 and associated data 111. The client machine 108 is connected, as depicted by 113, to a network 106. The client machine 108 together with the aforementioned components is referred to as the “client side” of the system 100, as depicted by a reference numeral 107.

An SSP platform 101 has a memory 102 storing a support application 103 and associated data 104. The SSP machine 101 is connected, as depicted by 112, to the network 106.

The SSP machine 101 together with its associated components is referred to as the “support side” of the system 100, as depicted by an arrow 105.

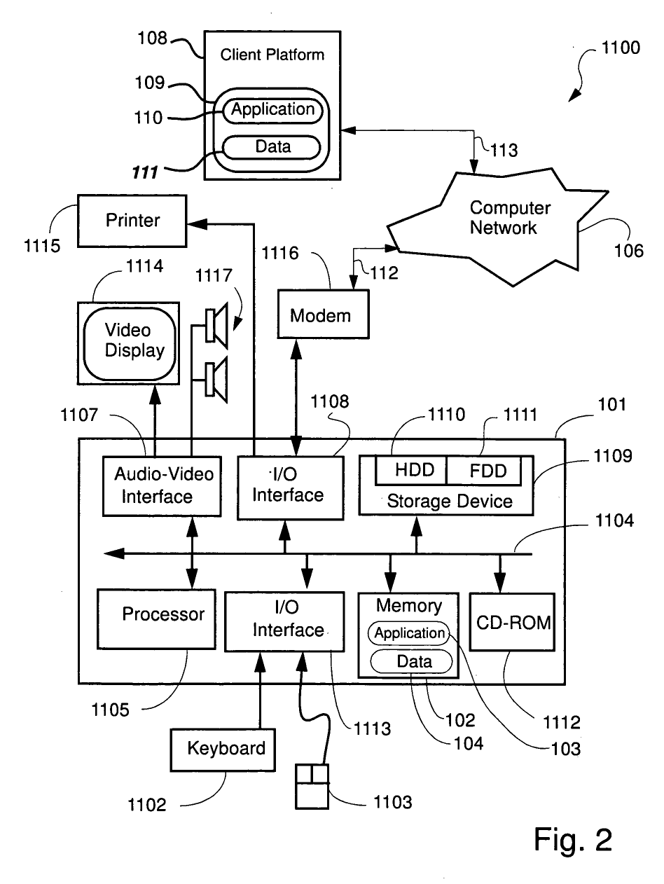

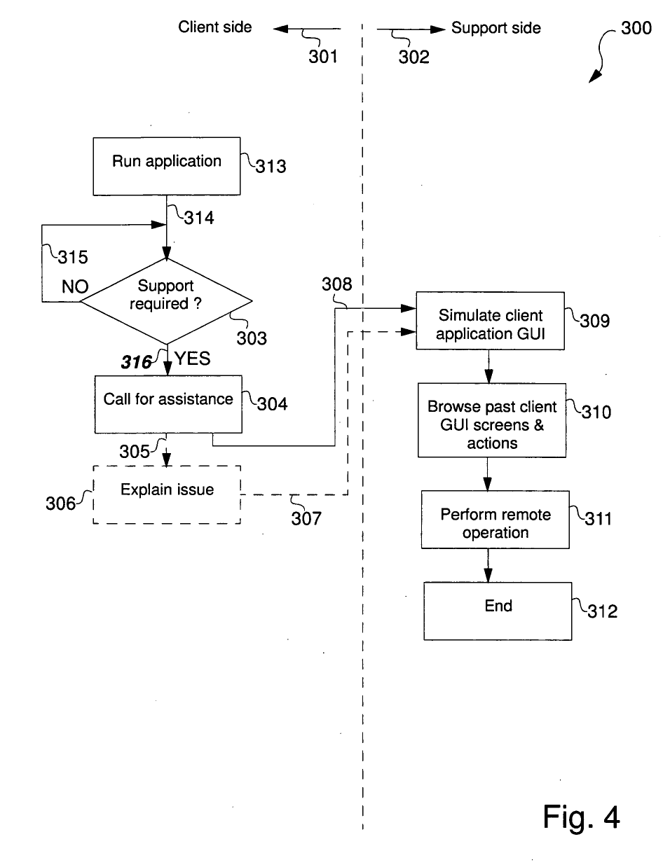

FIG. 2 shows a general purpose computer system upon which the disclosed GLTR method can be practiced. The GLTR method particularly lends itself to implementation on the general-purpose computer system 1100, such as that shown in FIG. 2 wherein the processes of FIGS. 4 and 6-15 may be implemented as software, such as an application program executing within the computer systems 1100. In particular, the steps of the GLTR method are effected by instructions in the software that are carried out by the computers. The instructions may be formed as one or more code modules, each for performing one or more particular tasks.

The software may also be divided into two separate parts, in which a first part performs the GLTR methods and a second part manages a user interface between the first part and the user. The software may be stored in a computer readable medium, including the storage devices described below, for example. The software is loaded into the computer from the computer readable medium, and then executed by the computer. A computer readable medium having such software or computer program recorded on it is a computer program product. The use of the computer program product in the computer preferably effects an advantageous apparatus for the GLTR approach.

The computer system 1100 is formed by the SSP computer module 101, input devices such as a keyboard 1102 and mouse 1103, output devices including a printer 1115, a display device 1114 and loudspeakers 1117. A Modulator-Demodulator (Modem) transceiver device 1116 is used by the computer module 101 for communicating to and from a communications network 1120, for example connectable via a telephone line 1121 or other functional medium to the client machine 108. The modem 1116 can be used to obtain access to the Internet, and other network systems, such as a Local Area Network (LAN) or a Wide Area Network (WAN), and may be incorporated into the computer module 101 in some implementations.

The computer module 101 typically includes at least one processor unit 1105, and the memory unit 102, for example formed from semiconductor random access memory (RAM) and read only memory (ROM). The module 101 also includes an number of input/output (I/O) interfaces including an audio-video interface 1107 that couples to the video display 1114 and loudspeakers 1117, an I/O interface 1113 for the keyboard 1102 and mouse 1103 and optionally a joystick (not illustrated), and an interface 1108 for the modem 1116 and printer 1115.

In some implementations, the modem 1116 may be incorporated within the computer module 101, for example within the interface 1108. A storage device 1109 is provided and typically includes a hard disk drive 1110 and a floppy disk drive 1111. A magnetic tape drive (not illustrated) may also be used. A CD-ROM drive 1112 is typically provided as a non-volatile source of data. The components 1105 to 1113 of the computer module 101, typically communicate via an interconnected bus 1104 and in a manner which results in a conventional mode of operation of the computer system 1100 known to those in the relevant art. Examples of computers on which the described arrangements can be practised include IBM-PC's and compatibles, Sun Sparcstations or alike computer systems evolved therefrom.

Typically, the application program is resident on the hard disk drive 1110 and read and controlled in its execution by the processor 1105. Intermediate storage of the program and any data fetched from the network 1120 may be accomplished using the semiconductor memory 1106, possibly in concert with the hard disk drive 1110. In some instances, the application program may be supplied to the user encoded on a CD-ROM or floppy disk and read via the corresponding drive 1112 or 1111, or alternatively may be read by the user from the network 1120 via the modem device 1116.

Still further, the software can also be loaded into the computer system 1100 from other computer readable media. The term “computer readable medium” as used herein refers to any storage or transmission medium that participates in providing instructions and/or data to the computer system 1100 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 101. Examples of transmission media include radio or infra-red transmission channels as well as a network connection to another computer or networked device, and the Internet or Intranets including e-mail transmissions and information recorded on Websites and the like.

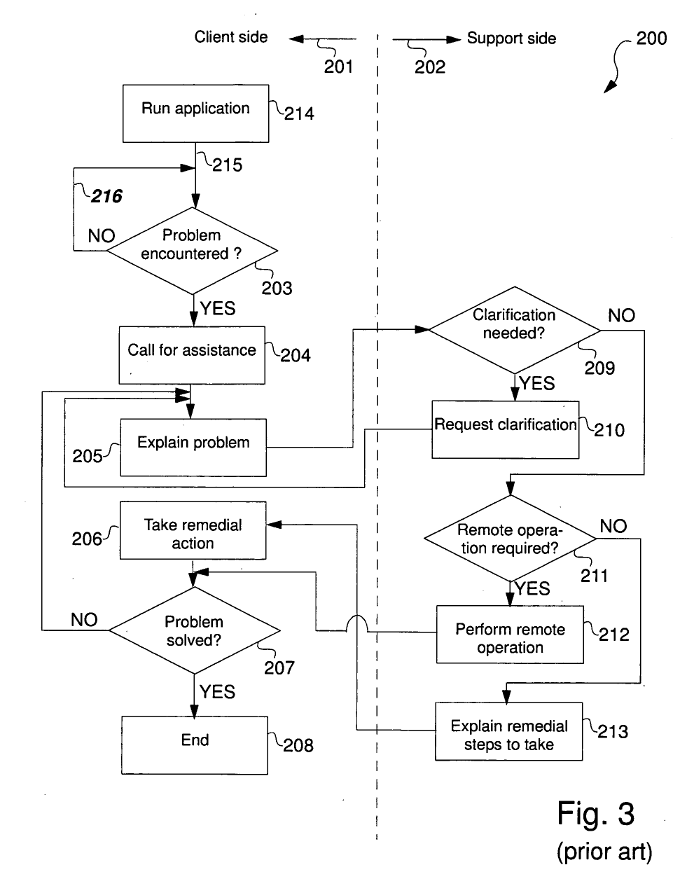

FIG. 3 shows a prior art remote support process 200 that can be practiced on the system 100 of FIG. 1. The process of providing remote support involves three main steps. Firstly, the client or the client system administrator, explains the problem, as far as he or she is able, to the SSP. The SSP then uses the problem description that has been provided by the client system administrator as a basis for diagnosing the problem. Then, the SSP provides instructions to the client system administrator to fix the problem. Turning to FIG. 3, on a client side 201 of the process 200 a client runs the application 110 on the client machine 108 in a step 214.

Thereafter, in a step 203, as long as no problems are encountered with running of the application 110 the process 200 follows a NO arrow back to the step 203. When, however, a problem is encountered with running the client application 110, then the process 200 follows a YES arrow from the step 203 to a step 204. At the step 204, the client or the client system administrator calls the SSP for assistance, after which in a step 205 the client explains the problem being encountered with the client application 103. The step 205 is typically performed using telephone calls and/or emails, and is subject to inaccuracy due to client expertise, accuracy of reporting and so on. The process 200 is then directed to a step 209 in which the SSP determines if further clarification is needed in regard to the explanation provided by the client in the step 205. If further clarification is required, then the process 200 is directed by a YES arrow to a step 210, in which the SSP requests further clarification. The process 200 is, in this case, directed back to the step 205 for the client to further explain the problem.

Returning to the step 209, if the SSP does not require any further clarification, then the system 200 follows a NO arrow to a step 211 in which the SSP determines if remote operation of the client application 110 on the client machine 108 is required. If this is the case, then the process 200 follows a YES arrow to a step 212. In the step 212, the SSP, using the platform 101 on the support side 202, remotely accesses the client application 110 on the client machine 108 on the client side 201, and remotely operates the client application 110 on the client machine 108. The SSP also takes remedial action in the step 212. The process 200 is then directed to a step 207 that determines whether the problem has been solved. If this is not the case, then the process 200 follows a NO arrow back to the step 205. If the step 207 determines that the problem has been solved, then the process 200 follows a YES arrow from the step 207 to a terminating step 208.

Returning to the step 211, if the SSP determines that remote operation is not required, then the process 200 follows a NO arrow to a step 213. In the step 213, the SSP explains to the client, typically by telephone or email, how to take remedial steps. The process 200 is then directed from the step 213 to a step 206 in which the client takes remedial action. The process 200 is then directed from the step 206 to the step 207.

FIG. 4 shows an arrangement 300 according to which the disclosed GLTR approach can be practiced on the system 100 of FIG. 1. The process 300 commences with a step 313 on the client side 301 in which the client runs the client software application 110 on the client machine 108. A following step 303 determines if a fault has been encountered in running the aforementioned client application 110, and as long as this is not the case, then the process 300 follows a NO arrow back to the step 303. When, however, a problem is encountered, the process 300 is directed to a step 304 by a YES arrow. In the step 304, the client calls for assistance, and according to one arrangement, the process 300 follows an arrow 308 to a step 309 on the support side 302. In this arrangement, the client does no more than report the fact that something has gone wrong, and does not explain the problem in any way.

Alternately, the process 300 can be directed from the step 304 to a step 306 (shown in dashed outline to indicate that this step is optional) in which the client explains the problem to the SSP on the support side 302 by telephone or email. In this case, the process 300 follows an arrow 307 to the step 309.

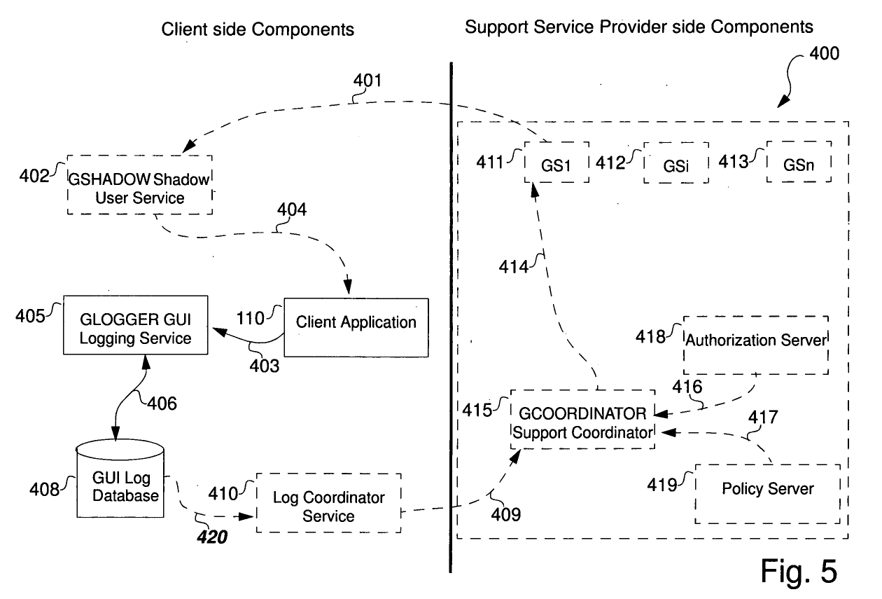

On the support side 302, the disclosed GLTR approach determines the nature of the problem based upon policies stored in a Policy Server 419 (see FIG. 5), and decides which support executive, stored in the Policy Server 419, is appropriate to solve the problem. The GUI logs (see 409 in FIG. 5) is then sent to a GUI simulator such as 411 in FIG. 5 running on the computer of the support executive which simulates, based on the GUI logs, some or all the logged historic user screen actions.

Returning to FIG. 4. In the step 309, on the support side 302, the disclosed GLTR system simulates Graphical User Interface (GUI) screens (also referred to as client GUI screens) of the client application 110, and in a following step 310, the SSP browses previous client GUI screens and associated client actions. In a following step 311, the SSP performs remote operation of the client application 110 on the client machine 108 from the support machine 101 using the GLTR SSP software application 103, in order to verify information that has been gleamed in step 310, and to take remedial action as and if necessary. The process 300 then terminates in an END step 312.

FIG. 5 shows a functional block diagram of a system 400 for implementing the disclosed GLTR approach. System components shown in dotted lines (ie 411-413, 415, 418 and 419 on the SSP side, and 402 and 410 on the client side) are invoked when the Support Service Application (SSA) 103 is invoked on the SSP machine 101. Operational steps shown in dotted lines (ie 401, 404, 420 and 409 on the client side, and 414, 416 and 417 on the SSP side) are also invoked when the Support Service Application (SSA) 103 is invoked on the SSP machine 101. The SSA 103 is invoked on the SSP machine 101, when the SSP machine 101 receives a support request (308, 307 in FIG. 4).

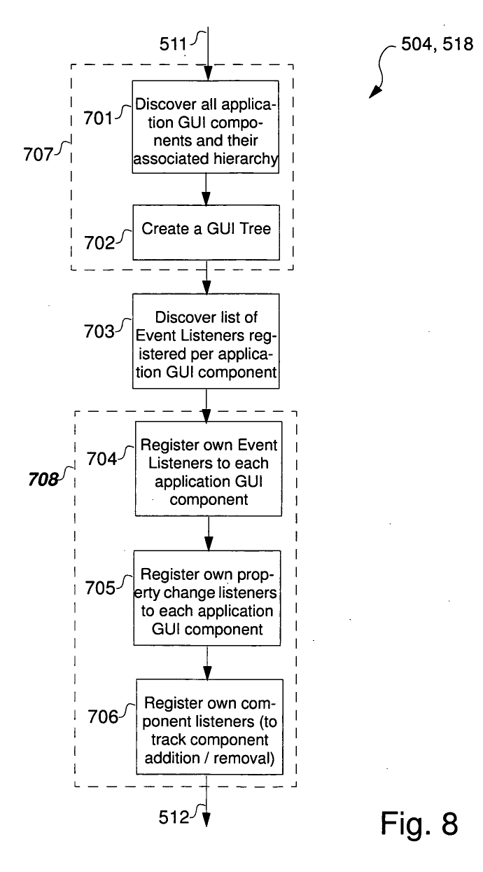

A GUI Logging Service 405, also referred to as GLOGGER in this description, (see FIGS. 8-10 for more detail) is initiated by the client application 110 on the start-up of the client application 110. The steps 403, 406 occur for each GUI operation on the client application 110. The steps 409, 414, 416 and 417 occur after invocation of the SSP application 103. The steps 401 and 404 occur for each GUI operation done by the SSP.

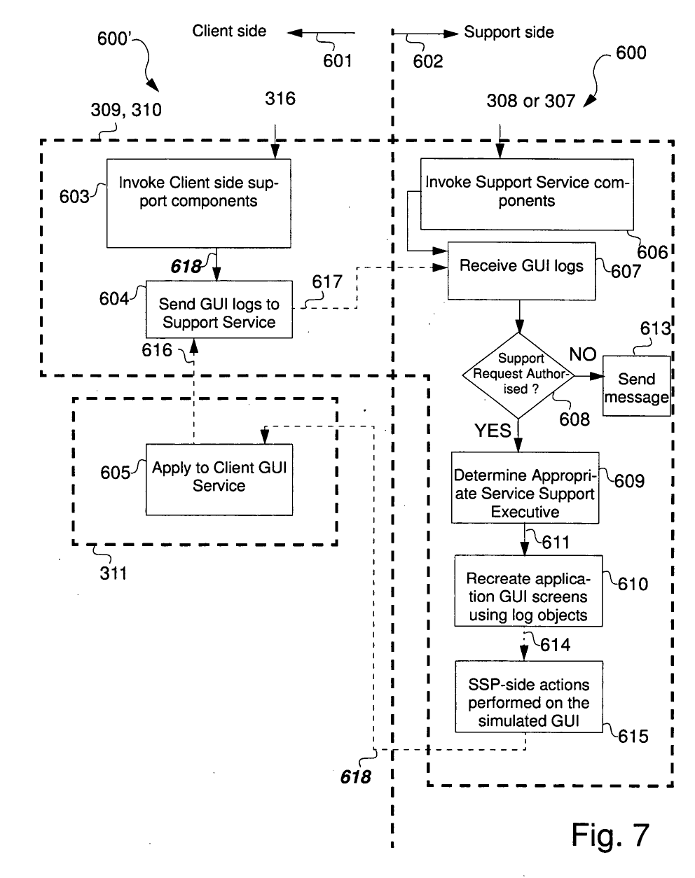

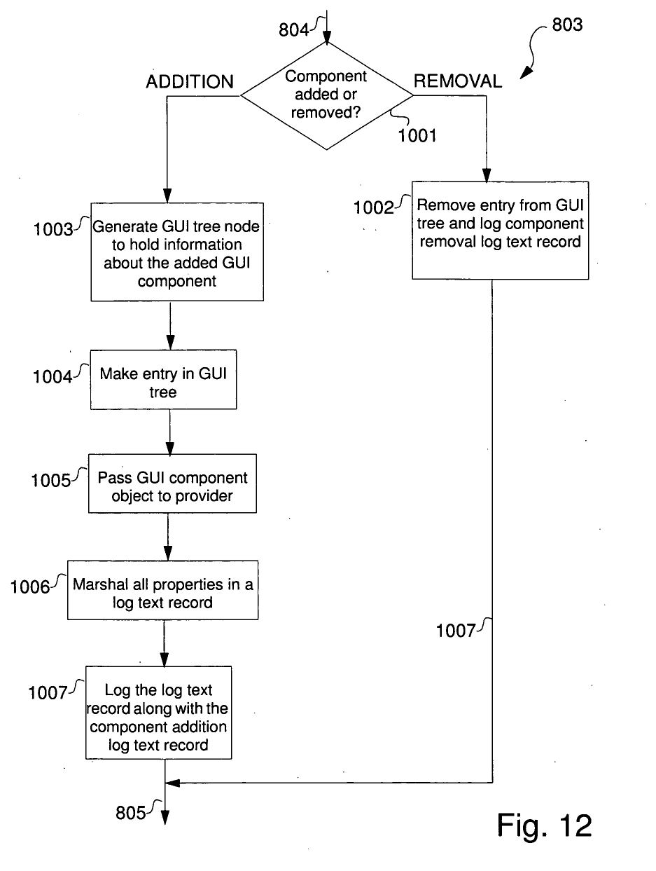

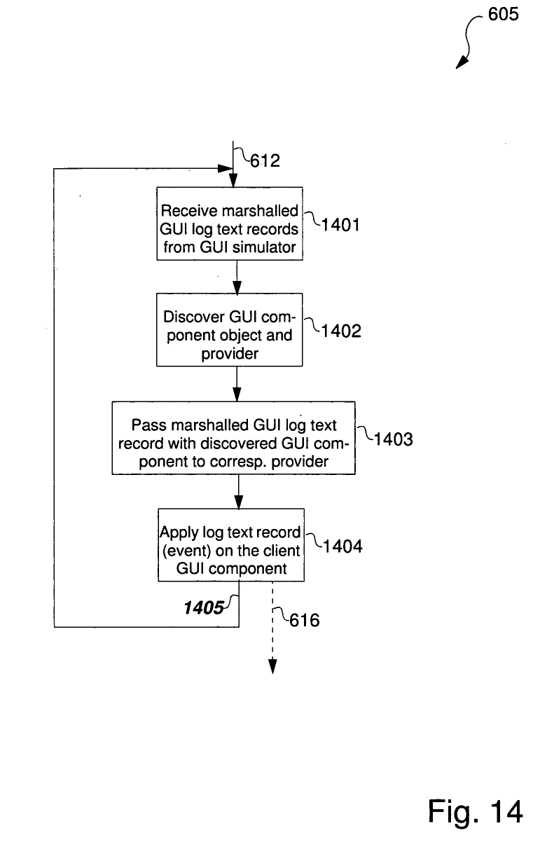

Typically the SSP application 103 incorporates the GUI simulators 411-413 (see FIG. 12 for more detail), and the Support Coordinator 415 (see FIG. 7 for more detail). The Authorisation Server 418 and the Policy Server 419 can reside in the SSP application 103, or elsewhere. The Shadow User Service 402 (see FIG. 14 for more detail) and the Log coordinator Service 410 reside on the client machine 108, possibly as part of the client application 110. In particular, the Shadow User Service 402 and the GUI logging service 405 run as components within the Client Application process 110 (see FIG. 5), typically in the form of a service that is invoked by the client application 110 via a calling function startLoggingService( ). The remainder of the relevant processing relating to the GLTR method and management of the GUI log database 408 (see FIG. 5) is managed by the GUI Logging Service 405. The GUI Logging Service 405 runs as an independent thread in the client application 110. The client application 110 thus does not provide any support to the GUI Logging Service 405 which performs all the processing required for logging.

The GUI log Database 408 is a partition in the data 111 of the memory 109 in the client machine 108.

When the client runs the client application 110, then the GUI Logging Service 405 (referred to as GLOGGER) is initiated. Each time the client application 110 causes a GUI event to occur, either by virtue of autonomous operation of the client application 110 or by virtue of a client action, an object of the GUI event is provided, as depicted by an arrow 403, to the GUI Logging Service 405. The aforementioned event object (i.e java.awt.event.ActionEvent) of the GUI event is provided by the Java Event Manager. It is noted, however, that the GUI Logging Service 405 “pulls” the GUI event object from the client application 110, or in other words, the client application 110 does not “push” the GUI event object to the GUI Logging Service 405. The GUI Logging Service 405 then stores, as depicted by an arrow 406, a corresponding GUI log text record in the GUI log database 408.

The GUI Logging service 405 logs GUI screens and actions in the form of GUI log text records and stores these log text records, as depicted by the arrow 406 in the GUI log database 408. The GUI Logging service 405 registers event handlers, which capture the aforementioned GUI events. The event handlers are registered to different GUI components on the application GUI. Accordingly, the GUI Logging service 405 logs all user actions and application GUI changes associated with the client application 110. The GUI Logging service 405 registers event handlers only for those events handled by the client application 110, thereby reducing the size of the log stored in the database 408 by a significant amount.

The GUI log text records stored, as depicted by the arrow 406, in the GUI log database 408 are text records that store information about the application GUI screen components and user actions. The GUI log text records belong to three different types, namely (a) component GUI log text records, (b) event GUI log text records, and (c) snapshot GUI log text records.

The component GUI log text records store all properties of the component, the list of event listeners registered by the client application 110 for the component, the layout of the GUI component and the component id which are generated by the GUI logging service 405, so that corresponding GUI components can be re-created from the component GUI log text records. The component GUI log text records also store hierarchy information associated with other components in the GUI tree.

The event GUI log text records store information about user actions and property changes of the GUI components. The event GUI log text record stores all information related to the event, the event id that uniquely identifies the event, and the corresponding component id, so that the event can be reproduced from the event GUI log text record on the SSP side.

The snapshot GUI log text record is a type of log text record that has sufficient information to construct an application GUI screen that occurred at a particular time in the past. The snapshot GUI log text record is generally used in order to pack several events/actions into a single log text record, typically in order to reduce memory and communication transmission bandwidth requirements.

As noted, the elements of the system 400 shown in dashed line formats are invoked when service support is requested. Accordingly, on the support service provider side, the Support Coordinator 415, the Authorisation Server 418, the Policy Server 419, and the GUI simulators 411, 412 and 413 are invoked. There can be any number of GUI simulators, at least one with each support executive. Typically one of the aforementioned GUI simulators is invoked for one service support request. On the client side, the Shadow User Service 402, and the Log Coordinator Service 410 are invoked when the support service is invoked by virtue of the client reporting a fault.

During normal operation of the client application 110, every GUI operation results in logging of a GUI event as depicted by 403, and storage of a corresponding GUI log text record as depicted by 406.

Upon receipt of a support request and consequent invocation of the SSA 103, the Log Coordinator Service 410 accesses, as depicted a dashed arrow 420, the GUI log text records stored in the GUI log database 408. The Log Coordinator Service 410 then provides, as depicted by a dashed arrow 409, the aforementioned GUI log text records to the Support Coordinator 415. The Support Coordinator 415 determines whether the support request is authentic, by invoking, as depicted by a dashed arrow 416, the Authorisation Server 418. If this results in an authorisation of the service request, then the Support Coordinator 415 invokes the Policy Server 419 and receives, as depicted by a dashed arrow 417, an appropriate support service executive from the Policy Server 419 to handle the support request. The Support Coordinator 415 then transfers the GUI log text records, as depicted by a dashed arrow 414, to the GUI simulator 411 of the support executive.

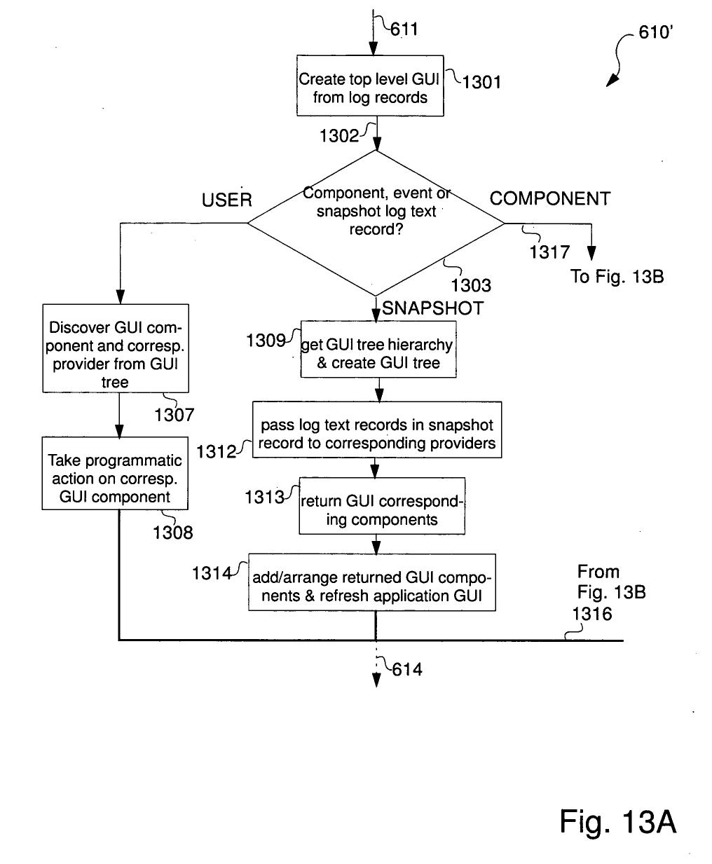

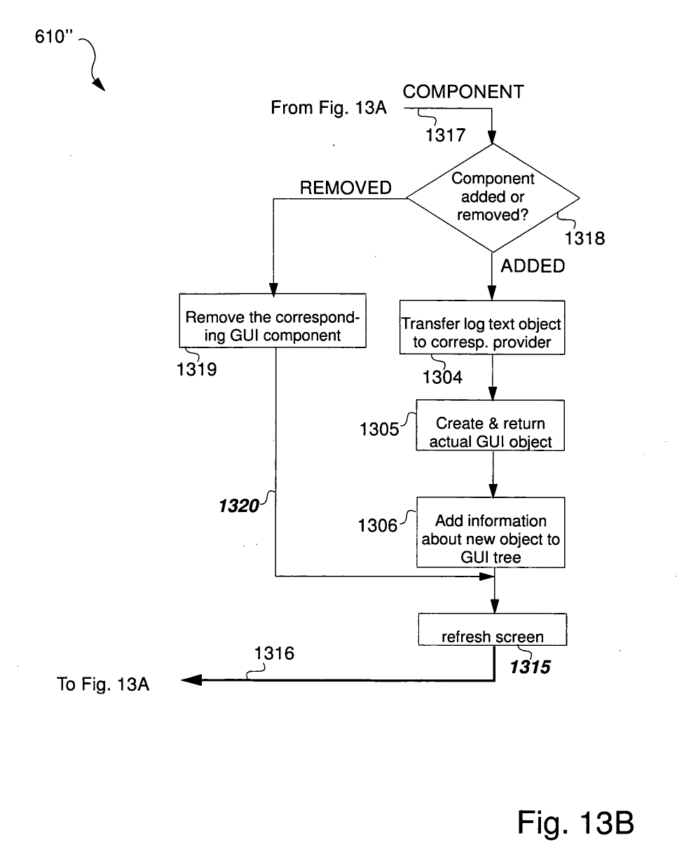

The client application GUI may change after invocation of the support service (see 606 in FIG. 7) in response to programmatic actions arising from actions applied by the Shadow User Service (see 311 in FIG. 4). These changes need to be reflected in the simulated GUI's (see 309 in FIG. 4), and in order to ensure that this occurs, the Log Coordinator Service 410 continues to send new GUI log text records, arising after invocation of the support service, to the Support Coordinator 415 which are sent to the relevant GUI simulator. These new GUI log text records are applied as shown in FIGS. 13A and 13B.

The GUI simulator 411 enables the SSP to re-create the client application GUI screens using the GUI log text records. The GUI log text records capture all past client GUI screens and actions, and this enables the SSP to browse past client application GUI actions and screens, in order to understand the operation of the client application 110. The SSP can also, as depicted by a dashed arrow 401, use the Shadow User Service 402 to apply, as depicted by a dashed arrow 404, actions taken in regard to the simulated GUI to the Client Application 110. This enables remote operation of the Client Application 110 by the SSP on the support side.

The disclosed implementation of the GLTR systems and methods, which is only a representative implementation, uses the Java (Version 1.3) language. Accordingly, the disclosed implementations support the applications that are implemented in the noted Java language. The Java Abstract Window Toolkit™ and Swing™ Application Process Interfaces (API's) are used. The GUI Logging Service 405 (GLOGGER), the GUI Shadow User Service 402 (GSHADOW), and the GUI simulator component 411-413 (GSIM) are implemented based on the provider-based architecture. This architecture has a main layer, and providers for each GUI component. The main layer provides specification of the API's that are to be supported by the providers. The main layer does generic processing and uses the provider functions for the processing specific to the GUI components. Although the description uses the Java language, other languages that provide event handling APIs that are functionally equivalent to those referred to in relation to Java, can be used.

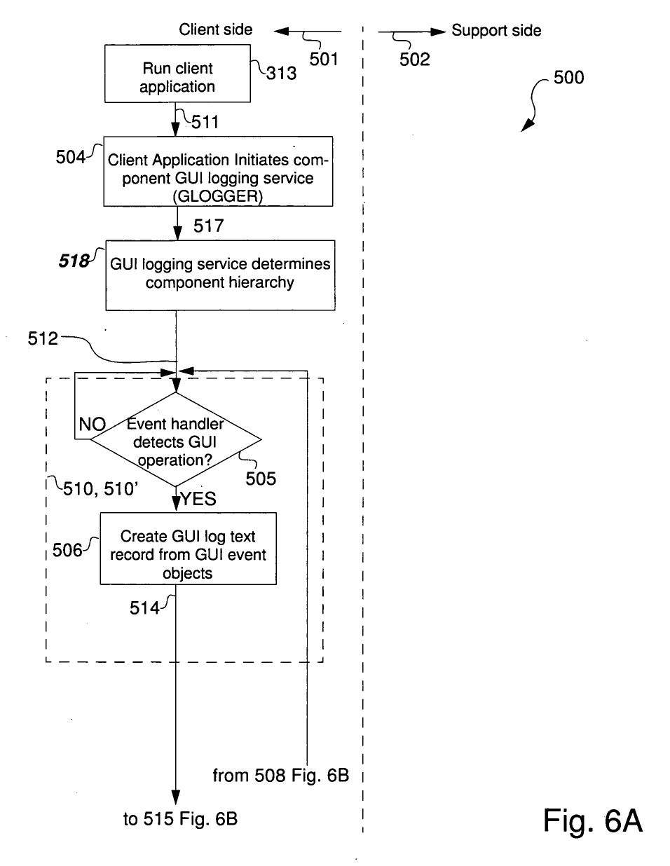

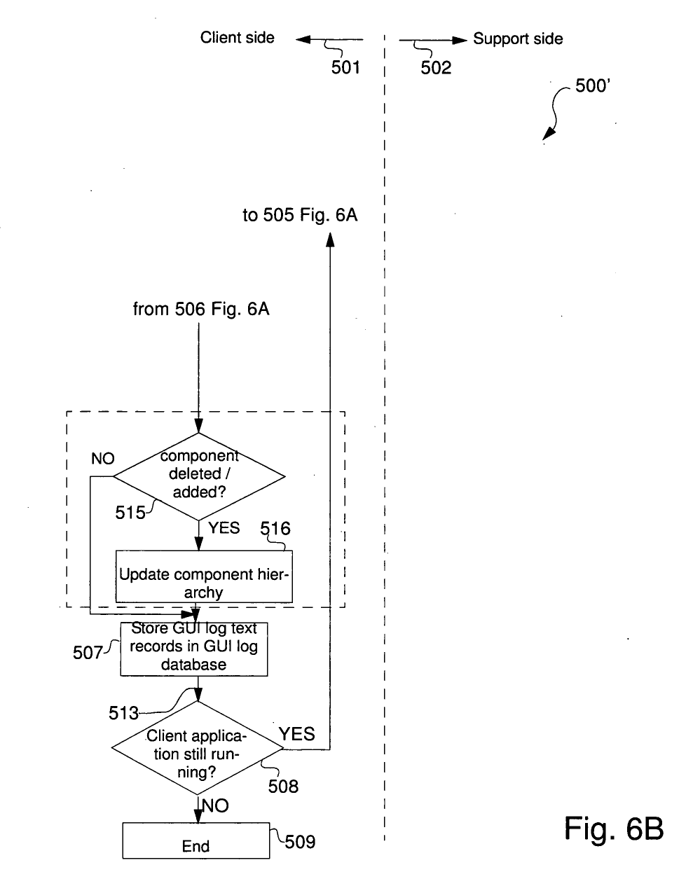

FIGS. 6A and 6B show process fragments 500 and 500′ that depict normal operation of the client application 110 (see FIG. 5). The process fragments 500 and 500′ relate to the client side 501. The process fragment 500 commences with a step 313 in which the client runs the client application 110 on the client machine 108 (see FIG. 1). In a following step 504 the client application 110 initiates the GUI Logging service 405. In a following step 518 the GUI Logging service 405 acquires a list of the top-most level client application GUI components as an input, and determines a component hierarchy associated with the GUIs. Once the GUI Logging Service 405 has been initiated, a step 505 determines if a GUI operation has been detected by an appropriate event handler. If this is not the case, then the process 500 follows a NO arrow back to the step 505. If, on the other hand, a GUI operation has occurred, then the process 500 follows a YES arrow to a step 506. In the step 506, the GUI Logging service 405 creates GUI log text record for the corresponding detected GUI event. A subsequent step 515 (shown in FIG. 6B) determines if a component has been removed from or added to the component hierarchy (see FIG. 12). If this is the case, the process 500 follows a YES arrow to a step 516 which updates the component hierarchy associated with the GUIs. If no component has been removed or added, then the process 500 follows a NO arrow from the step 515 to a step 507.

The following step 507 stores the GUI log text records in the GUI log database 408. In a following step 508 the GUI Logging service 405 determines if the client application 110 is still running. If this is the case, then the process 500 follows a YES arrow back to the step 505 in FIG. 6A. Returning to the step 508 in FIG. 6B, if the GUI Logging service 405 determines that the client application 110 is not running, the process 500 is directed by a NO arrow from the step 508 to a terminating step 509. From a practical perspective, in a preferred arrangement the GUI Logging Service 405 runs as a thread in the Client Application 110, and so when the Client Application 110 terminates, the GUI Logging Service 405 also terminates.

FIG. 7 shows process-flow/data-flow fragments 600 and 600′ according to which the Service Support Application 103 (see FIG. 1) operates. Arrows in solid line format such as 618 indicate the manner in which the process in question progresses from a step at the origin of the arrow in question (eg a step 603 is at the origin of the arrow 618) to a step at the destination of the arrow in question (eg a step 604 is at the destination of the arrow 618). In contrast, arrows in dotted line format such as 617 indicate the manner in which data flows from a step at the origin of the arrow in question (eg the step 604 is at the origin of the arrow 617) to a step at the destination of the arrow in question (eg a step 607 is at the destination of the arrow 617).

The fragment 600 commences with a support request, depicted by the arrow 308, or the arrow 307 (see FIG. 4) which arise when the client, or alternatively the client application 110 request assistance. The fragment 600′ is also initiated with a support requestas depicted by the arrow 316 (see FIG. 4).

Once the request for assistance is received at the support side 602, a step 606 invokes support service components on the support side. These support service components are the GUI simulators 411, 412 and 413, the Support Coordinator 415, the Authorisation Server 418, and the Policy Server 419. The fragment 600 is then directed to a step 607. The step 603 invokes client side support components. These components include the Log Coordinator Service 410, and the Shadow User Service 402. In a following step 604, the Log Coordinator Service 410 accesses GUI log text records in the GUI log database 408, and sends the GUI log text records, as depicted by a dotted arrow 617, to the Support Coordinator 415 on the support side 602. In the step 607, the Support Coordinator 415 receives the aforementioned GUI log text records, after which in a step 608, the Support Coordinator 415 queries the Authorisation Server 418 to determine if the support request is authorised. If this is the case, then the process 600 follows a YES arrow to a step 609. In the step 609, the Support Coordinator 415 determines, by querying the Policy Server 419, the appropriate service support executive. Returning to the step 608, if the authorisation service 418 indicates that the support request is not authorised, then the process 600 follows a NO arrow to a step 613, which sends a message to the Support Coordinator 415 to the effect that the service request is not authorised and cannot be granted. The Support Coordinator 415 passes this, as an error message, to the Client Application 110.

Once the Policy Server 419 provides the appropriate service support executive to the Support Coordinator 415 in the step 609, the fragment 600 is directed, as depicted by an arrow 611, to a step 610 in which the GUI simulators, such as 411, recreates application GUI screens using GUI log text records sent by the client side. In the step 610, the SSP on the support side 602 can browse the historic GUI screen and user action information until a determination has been made of what the issue might be.

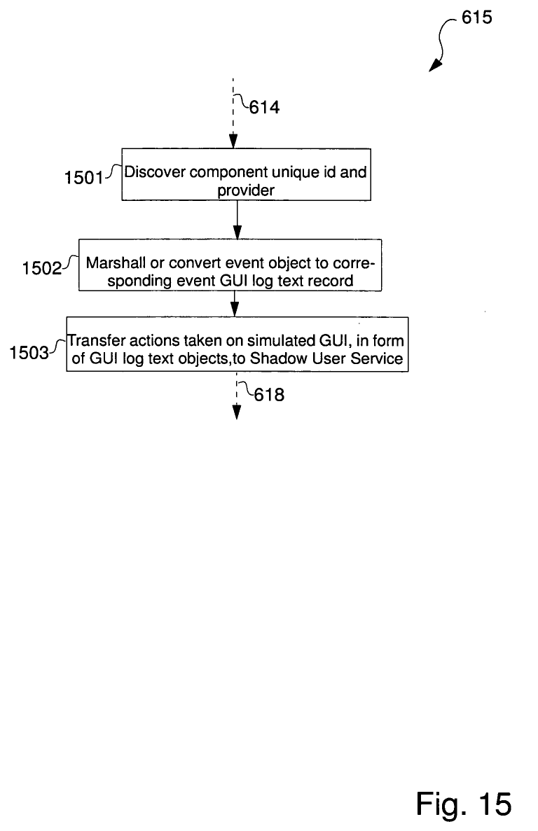

Once the step 610, described in more detail in regard to FIGS. 13A and 13B, has recreated the application GUI screens, as depicted by a dotted arrow 614, actions can be taken on the simulated GUI screens on the SSP side 602, as depicted by a step 615. This is described in more detail in regard to FIG. 15.

GUI actions taken by the SSP on the simulated GUI in the step 615, are transferred as GUI log text records as depicted by a dashed arrow 618 to a step 605 in which the Shadow User Service 402 on the client side 601 remotely operates the client application 110 as described in more detail in regard to FIG. 14.

The above operation of the client application by the Shadow User Service 402 in the step 605 can cause changes in the client application GUI. These changes need to be mirrored on the SSP simulated GUI. In order to achieve this, the Shadow User Service 402 sends, as depicted by a dashed arrow 616, GUI log text records to the Log Coordinator Service 410. The GUI log text records, passed by the Log Coordinator Service, are used by the step 610 to update the simulated GUI screens, as described in more detail in regard to FIGS. 13A and 13B.

Accordingly, the step 610 processes GUI log text records sent by the Support Coordinator Service 415 on initial support invocation in the same manner as the step 610 processes GUI log text records arising due to actions taken by the Shadow User Service 402 in the step 605.

As already described, in order to reflect the client application GUI changes that occur in response to programmatic actions taken by the Shadow user service 402, the GUI log coordinator service 410 continues sending new GUI log text records (these being records stored after support invocation) that are stored in the GUI log database 408 by the GUI logger service 405. It is noted that the log coordinator service 410 does not send the GUI log text records corresponding to the actions taken by the Shadow user service 402, but only sends the GUI log text records corresponding to application GUI changes that occur in response to the programmatic actions taken by the Shadow user service 402. The log text records sent as depicted by 616 are used to differentiate between the log text records corresponding to the actions taken by the Shadow user service and the client application GUI changes.

FIG. 8 shows a process according to which the GUI Logging service 405 is initialised in the steps 504 and 518 of FIG. 6A. The GUI Logging Service 405 performs logging of the GUI events and screens. The GUI Logging Service 405 is initialised upon registration of the client application 110 list of top-level GUI component objects. The GUI Logging Service 405 performs logging of GUI actions and screens that occur after registration. Most often, the client application 110 registers to the GUI logging service 405 at the start-up of the client application 110, however this registration can be performed any time. If the registration is performed after start-up then the GUI Logging service will not have acquired any application GUI information that occurred before registration. As a consequence, the system will not be able to reproduce (ie simulate) the GUI screens/actions that occurred before the registration.

The initialisation of the GUI Logging Service 405 involves three steps. Firstly, the GUI Logging Service 405 discovers all the GUI components and their associated hierarchy, using the GUI parent child relationship API's provided by Java. In this manner, the GUI Logging Service 405 creates a GUI tree, which has all information about the GUI components present in the GUI of the client application 110. Note that the GUI tree has information about the GUI components instead of the GUI component objects, and furthermore, each GUI component is identified by a unique id generated by the GUI Logging Service 405.

Secondly, the GUI Logging Service 405 discovers the list of event listeners registered per GUI component of the client application 110. Therefore, the GUI Logging Service 405 knows GUI events being handled by the client application 110. Thirdly, the GUI Logging Service 405 registers it's own event listeners to each GUI component. In other words for each event handler registered by the client application 110, the GUI Logging Service 405 also registers a separate event listener. In this manner the GUI Logging Service 405 captures all the user actions that are handled by the client application 110.

The GUI Logging Service 405 also registers other listeners to keep track of addition, removal, and property change of the GUI components. The GUI Logging Service 405 registers property change listener to each GUI component, to keep track of property change of the GUI components. The GUI Logging Service 405 registers component listeners to keep track of GUI component removal and addition. Most of the GUI components provide the above-mentioned listeners. If this is not the case, then the listeners can be implemented using a probing mechanism and event listener APIs provide by the language (i.e. Java). The aforementioned listeners probe different GUI components in order to capture the changes. The probing can be event based (in which case every time a GUI screen is refreshed, a corresponding top level component changes) or the probing can be interval based (in which case the user can specify the time interval between probes). One possible efficient implementation of the property change listener would be that, it checks property (i.e text in JTextField) change of the components when any of the user event handlers reports an event. Such property change event listener will ensure that the logs are updated when user took an action that was captured by the client application. Note: the terms event handlers and listeners refer to the code that captures the events/actions and passes them to the logging service.

The process 504 commences with a step 701, in which the GUI Logging service 405 discovers all application GUI components and their associated hierarchy. Thereafter, in a step 702, the GUI Logging service 405 creates a GUI tree. In a subsequent step 703, the GUI Logging service 405 discovers a list of event listeners registered per application GUI component. Thereafter, in a step 704, the GUI Logging service 405 registers its own event listeners to each application GUI component. Subsequently, the GUI Logging service 405 registers its own property change listeners to each application GUI component. In a subsequent step 706, the GUI Logging service 405 registers its own component listeners to track component addition and/or removal. The process 504 then follows the arrow 512 to the step 505 in FIG. 6A.

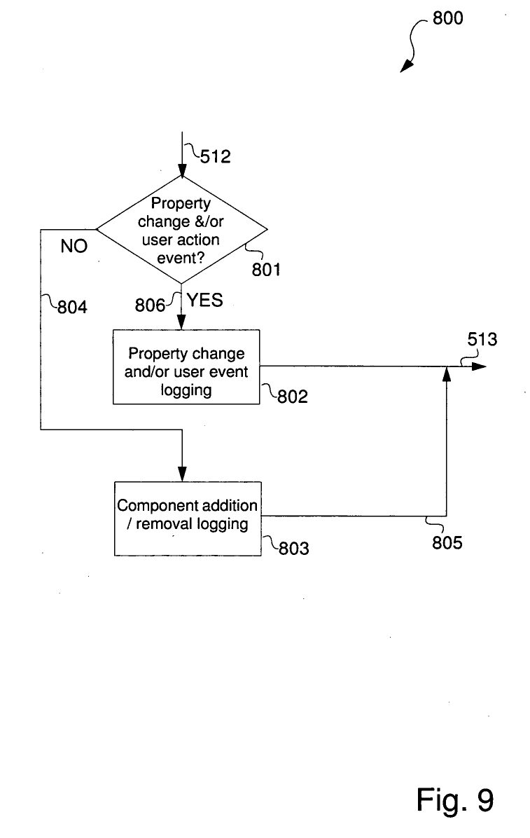

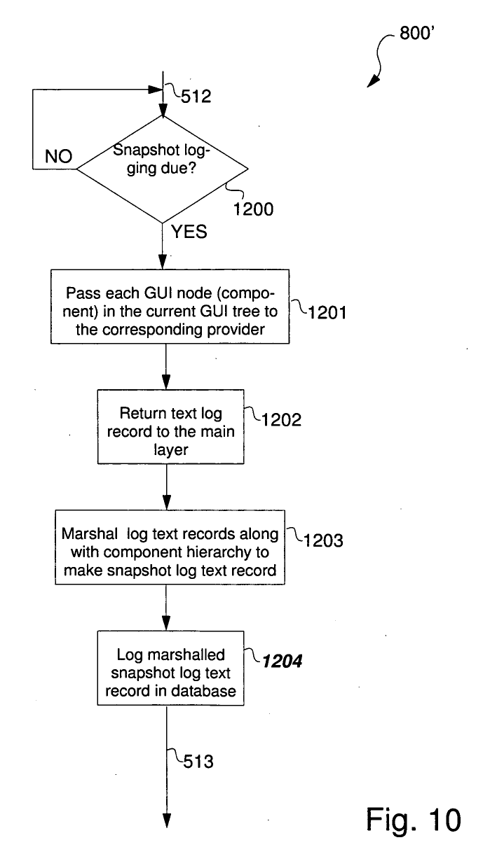

FIGS. 9 and 10 show the process flow commencing after the step 518 in FIG. 6A and proceeding up to the step 508 in FIG. 6B. This process comprises two process threads designated 800 and 800′. The processes 800 and 800′ are depicted in prime format they represent two concurrently running processes. The process 800 is described in relation to FIG. 9, and the concurrent process 800′ is described in relation to FIG. 10.

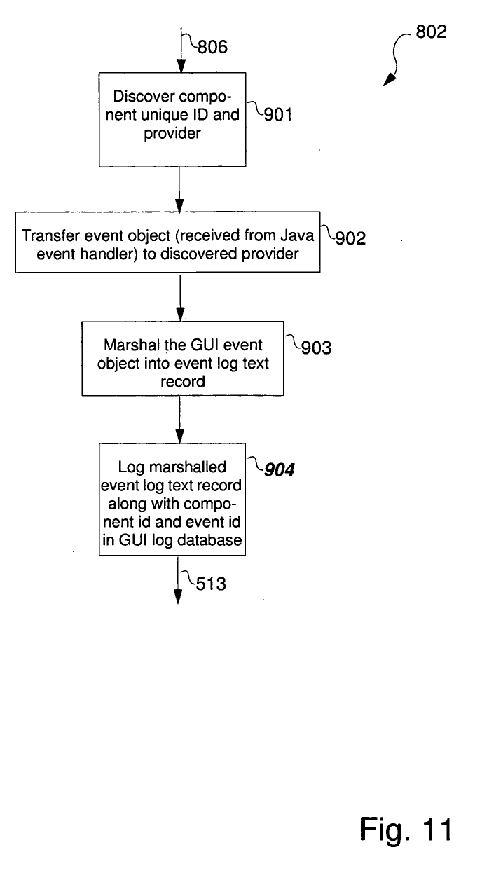

The process 800 commences with a step 801, in which the GUI Logging service 405 determines if the detected GUI operation relates to a property change and/or a user action event. If this is the case, then the process 800 follows a YES arrow to a step 802. In the step 802, the GUI Logging service performs a property change and/or user action event Logging process that is described in more detail in regard to FIG. 11. Once the process 802 has been completed, then the process 800 follows the arrow 513 to the step 508 in FIG. 6B.

Returning to the step 801, if the GUI Logging service 405 determines that the GUI operation that has occurred is not related to a property change and/or user action event, then the process 800 follows a NO arrow to a step 803. In the step 803, the GUI Logging service 405 performs a component addition and/or removal logging operation, which is described in more detail in regard to FIG. 12. Once the step 803 is completed, then the process 800 is directed from the step 803, via an arrow 805 to the step 508 in FIG. 6B.

FIG. 10 shows the process thread 800′, which runs concurrently to the process 800 that has been described in relation to the FIG. 9. In the process 800′, the GUI Logging service 405 deals with a different type of event Logging in which the composite log of the events in question is compressed into a snapshot. The GUI screens and user actions are logged in form of text records so the logging overhead will be close to minimal, as is generally the case with the disclosed GLTR approach.

The snapshot log text record is best described by means of an example as follows. The snapshot log text record is a type of log text record that has sufficient information to construct an application GUI screen that occurred at a particular time in the past. It is generally used in order to pack several events into a single log text record, typically in order to reduce memory and communication transmission bandwidth requirements. Thus, for example, if a particular client application has four buttons, and following a series of user and programmatic actions the following sequence of events has occurred:
(1) button 1 clicked;
(2) button 2 clicked;
(3) button 3 clicked;
(4) button 2 removed;
(5) text box added.

Having regard to the above-noted example, if each event is captured (ie logged individually), then it is necessary to capture five individual events in the form of five corresponding event log text records. In the case, however, where the client application is running for a long period of time and a large number of actions have occurred, then storing individual log text records for each event consumes a great deal of memory. In such a case, it is possible to adopt the “snapshot event record” approach, which effectively compresses several events into a single snapshot log text record. Returning to the above-noted example which has five individual events, the corresponding snapshot log text record will store information in the following form:
Button 1 (clicked state), Button 3 (clicked state), Button 4 (not clicked state), One text box.

The aforementioned snapshot log text record clearly does not store any timing information of when the various changes and/or actions occurred. The snapshot log text record only stores the aggregate effect of all the action and/or changes. From a granularity perspective, snapshot records can be logged at time intervals decided by the user of the client application. Therefore, snapshot log records can be logged hourly, daily or at any convenient frequency. This enables the large number of individual log text records to be deleted from memory, thereby saving significant amounts of memory capacity in some cases. In practice, the user typically keeps individual log text records for the recent past (eg., the previous one or two days), with actions logged prior to that time being compressed as snapshot log text records on an hourly basis.

Having regard to the snapshot GLTR example previously described, it is evident that logging overheads are further minimized by creating GUI snapshots that are generated at a time granularity defined by the user of the client application 110. The GUI snapshot log text record is a log of the GUI tree that has complete information about all the GUI components, in the GUI of the client application 110, which were present at the time of the snapshot generation. The GUI snapshot log text record has complete information about all GUI components present at a given time on the GUI of the client application 110. The GUI snapshot is not stored in form of events or actions, but rather as a marshaled copy of the GUI tree.

In other cases, the client application GUI screens are stored in the form of differences from previous screens. It is noted that generally, user actions such as a mouse click, or programmatic actions/property change events such as setText are logged as corresponding event log text records. Accordingly, for each change in the client application GUI, the GUI Logging Service 405 typically adds a log text record to the log. However, if the number of log text records exceeds a predetermined threshold, the GUI Logging Service 405 reduces the logging overhead by creating snapshot log text records that combine previous log text records. The granularity with which log text records are compressed into snapshot records is set by the user of the client application 110. Examples of differences are (a) user actions such as a mouse click, or (b) programmatic actions such as the actions taken programmatically for example the setText command.

The process thread 800′ commences with a step 1200 in which the GUI Logging service determines if a snapshot Logging operation is due (according to the client application user defined time granularity). If this is not the case, then the process 800′ is directed by a NO arrow back to the step 1200. If, on the other hand, a snapshot Logging event is due, then the process 800′ follows a YES arrow to a step 1201. In the step 1201 the main layer passes each GUI node (component) in the current GUI tree to the corresponding provider. In a following step 1202 the corresponding provider returns a component log text record to the main layer. Thereafter in a step 1203 the main layer marshals the component log text records, returned for each GUI node in the GUI tree, along with the component hierarchy, to make a snapshot record. In a following step 1204 the main layer logs the marshalled snapshot log text record in the database 408. The process 800′ is then directed by the arrow 513 to the step 508 in FIG. 6B.

The term “marshal” is used to represent the step in which the corresponding provider converts the GUI component object to a corresponding component GUI log text record (i.e JButton), and the GUI event object (i.e java.util.ActionEvent or PropertyChangeEvent) into a corresponding event GUI log text record.

It is noted that the component GUI log text record for any GUI component returned from the corresponding provider has all the properties of the corresponding GUI component. This is the reason that the GUI component can be re-created on the SSP side from the component log text record. Thus, for example, the JButton provider stores all the properties of a given JButton component in the component log text record, so that the same JButton GUI component can be re-created from the component log text record on the SSP side.

FIG. 11 shows the step 802 from FIG. 9 in more detail. The processing for the property change and user action event involves three steps. Firstly, the main layer discovers the component unique id and the provider. Then the main layer transfers the event object (received from the Java event manager) to the discovered provider, which marshals the GUI event object into an event log text record. The marshaled event log text record is then logged by the main layer along with the component id and event id, which are generated by the main layer. It is noted that the event log text record stores all information related to the event, and the corresponding component id, so that the event can be reproduced from the event GUI log text record on the SSP side.

Returning to FIG. 11, the process 802 commences with a step 901 in which the main layer discovers the component unique ID and the appropriate provider. Thereafter, in a step 902, the main layer transfers the event object to the discovered provider. Subsequently, in a step 903, the provider marshals the GUI event object into an event log text record. In a subsequent step 904, the main layer logs the marshalled event log text record, along with the component id and event id, in the GUI log database 408, and the arrow 513 then directs the process 802 to the step 508 in FIG. 6B.

FIG. 12 shows the step 803 from FIG. 9 in more detail. The processing of the component addition/removal event involves processing depending upon the removal or addition of the component. In case of the GUI component removal, the main layer removes the entry from the GUI tree and logs the component removal log text record. The component removal log text record contains the component id and hierarchy information about the deleted component. The processing of the GUI component addition event is done in three steps. Firstly, the main layer generates a GUI tree node to hold information about the added GUI component and makes its entry in the GUI tree. This step mainly involves generating a unique id, determining its provider, and determining the parent child relationship. Second, the GUI component object is passed to the provider, which marshals all properties of the component in a component log text record. Thirdly, the main layer logs the component log text record along with the component addition log text record. The component addition log text record holds hierarchy information about the added GUI component. It is noted that the GUI Logging Service 405 logs all GUI components, in the client application GUI screens, in form of several component addition events (log records).

Returning to FIG. 12, the process 803 commences with a step 1001 in which the GUI Logging service 405 determines if a component is to be added or removed. If the component is to be removed, then the step 803 follows a REMOVAL arrow to a step 1002. In the step 1002, the main layer removes the entry from the GUI tree, and logs a component removal log text record. The step 803 then follows an arrow 1007 to the arrow 805 in FIG. 9.

Returning to the step 1001, if the GUI Logging service 405 determines that a component has been added, then the step 803 is directed by an ADDITION arrow from the step 1001 to a step 1003. In the step 1003, the main layer generates a GUI tree node to hold information about the added GUI component object. Thereafter, the main layer in a step 1004 makes its entry in the GUI tree. In a subsequent step 1005, the main layer passes the GUI component object to an appropriate provider. Thereafter, in a step 1006, the provider marshals properties of the component in a component log text record. In a subsequent step 1007, the main layer logs the component log text record along with the component addition log text record in the GUI log database 408. To capture the events related to the newly added component the main layer also performs steps 703, 704, 705, and 706 (shown in FIG. 8). The step 803 then follows an arrow 1007 to the arrow 805 in FIG. 9.

FIGS. 13A and 13B show the step 610 from FIG. 7 in more detail, this dealing with the GUI simulator process 411. The step 610 from FIG. 7 is depicted by process fragments 610′ and 610″ in FIGS. 13A and 13B respectively. The GUI simulator process 411 runs on the support provider side. The GUI simulator process 411 simulates the client application GUI using the GUI log text records received from the client side. As already described the GUI Logging Service 405 captures client application GUI screens in form of GUI component addition, removal, user action and property change events (log text records), usable to incrementally generate the client application GUI. User actions and property change events (log text records) are also applied one by one, to provide a facility for browsing through all previously invoked client application GUI screens. The GUI simulator process 411 also provides the facility for applying user actions in groups. This enables browsing user actions and corresponding GUI screens at lower granularity than per user action or event occurred at the client site.

The process of simulating the past and current client application GUI screens from the GUI log text records involves one initialisation phase, and then GUI log text records are applied incrementally. In the initialisation phase, the main layer creates the top level GUI components from the log text records generated by the client side GUI Logging Service 405.

The processing of each GUI log text record depends upon its type. The processing for component GUI log text records is as follows. The main layer transfers the component log text record to the corresponding provider, which in turn creates and returns actual GUI component. The information about the new component is added to the GUI tree, and the component is displayed on the screen. In the case of container components like Jpanel, the children GUI components are also passed along with the GUI log text record.

The processing of event log text record involves three steps. Firstly, the main layer discovers the GUI component and the corresponding provider from the GUI tree. Secondly, based on the information in the GUI event log text record, the provider takes programmatic action on corresponding GUI component.

The GUI snapshot log text record represents a complete GUI screen, and so it is processed as follows. The main layer uses the GUI component tree (ie the GUI screens) from the GUI tree given in the GUI snapshot log text record to create complete application GUI.

The GUI simulator process 411 also provides the facility for remote user actions on the present, simulated, GUI screen (which is the same as the client GUI). Accordingly, the actions taken on the simulated GUI are transferred, in form of GUI log text records, to the Shadow User Service 402 on the client side that in turn programmatically takes actions on the actual application GUI.

Returning to FIGS. 13A and 13B, and in particular turning to FIG. 13A, in an initial step 1301 of the process fragment 610′, the main layer creates a top level GUI from log text records. Thereafter, in a step 1303, the GUI simulator 411 determines if the log text record in question is of component type, or of an event type, or of a snapshot type. If the log text record is a component log text record, then the process fragment 610′ follows a COMPONENT arrow 1317 to a step 1318 in FIG. 13B. The step 1318 determines if the log text record relates to a component addition or a component removal type. If the step 1318 determines that it is a component addition type, then the process fragment 610″ is directed by an ADDED arrow to a step 1304. In the step 1304, the main layer transfers the corresponding component GUI log text record to a corresponding provider. In a following step 1305, the provider creates and returns the actual GUI component object. The provider also registers event listeners for the newly created GUI component, noting that the list of listeners is present in the component GUI log text record). Thereafter, in a step 1306, the main layer adds information about the new GUI component object to the GUI tree, and the GUI component returned by the provider is added to the parent component, noting that the hierarchy information is acquired from the component addition log text record. The process fragment 610″ is then directed to a step 1315 in which the main layer refreshes the screen 1114 (see FIG. 2) in order to display the new component on the screen 1114. The process fragment 610″ is then directed by an arrow 1316 back to FIG. 13A.

Returning to the step 1318, if the step determines that the log text record is of the component removal type then the process fragment 610″ is directed by a REMOVED arrow to a step 1319 in which the corresponding GUI component of the simulated GUI is removed. The process fragment 610″ is then directed by an arrow 1320 to the step 1315.

FIG. 15 shows how SSP-side actions on the simulated GUI screens are processed. The dashed arrow 614 in FIG. 13A depicts the fact that the GUI log text records received via 617 from the Log Coordinator Service 410 are processed to reflect client side GUI changes by the step 610 (see FIG. 7). Thereafter, in a step 1501 the main layer discovers the component unique id and the provider. In a following step 1502 the provider marshals or converts the event object (received from the Java event manager) to a corresponding event GUI log text record.

Thereafter, the main layer, in a step 1503, transfers actions taken on the simulated GUI, in the form of GUI log text records, to the shadow user service 402. Accordingly, for each action taken on the SSP simulated GUI, three steps are involved. In the first step 1501, the main layer discovers the component unique id and the provider. In the second step 1502, the corresponding provider marshals or converts the event object (received from the Java event manager) to a corresponding event GUI log text record. In the third step 1503, the event GUI log text record is transferred to the shadow user service.

Returning to the step 1303 in FIG. 13A, if it is determined that log text record is of an event type then the process 610 is directed by a USER arrow to a step 1307. In the step 1307, the main layer discovers the GUI component and the corresponding provider from the GUI tree. In a subsequent step 1308, the provider takes programmatic action on the corresponding GUI component.

Returning to the step 1303, if it is determined that, the log text record is of the snapshot type, then the process 610 follows a SNAPSHOT arrow to a step 1309. In the step 1309 the main layer gets the GUI tree hierarchy information from the snapshot log text record, and creates the GUI tree. The snapshot log text record has component log text records corresponding to each GUI node in the GUI tree. In a following step 1312 for each node in the GUI tree the main layer passes the corresponding component log text record present in the snapshot record to the corresponding provider. Thereafter, in a step 1313, the various providers return GUI components corresponding to the component log text records passed to them by the main layer in the step 1312. In a following step 1314, the main layer adds and/or arranges the returned GUI components according to the hierarchy information present in the snapshot log text record, and finally, the main layer refreshes the entire application GUI.

FIG. 14 shows the step 605 from FIG. 7 in more detail, this relating to the Shadow User Service 402. The Shadow User Service 402 runs on the client application side. The Shadow User Service 402 service receives the marshaled GUI log text records from the GUI simulator 411. The main layer uses the GUI tree prepared by the GUI Logging Service 405. The processing of the GUI log text record involves two steps. Firstly, the Shadow User Service 402 discovers the GUI component object and provider from the information present in the received GUI log text record. Secondly, the Shadow User Service 402 passes the marshaled GUI log text record along with the discovered GUI component to the corresponding provider. Thirdly, the provider applies the event (ie the corresponding log text record) programmatically on the GUI component. Thus, for example, if a button click log text record is received, the Shadow User Service 402 calls the doClick() method on the corresponding component.

The invocation of, for example, the doClick() method, creates an effect that is the same as that of the client application user. Thus, for example, invocation of the doClick() method generates the same effect on the GUI as the action of the user would have generated. Some GUI components provide API's that create an effect that is the same as a user action, but some GUI components may not do so. Accordingly, this feature is subject to the availability of such API's.

Returning to FIG. 14, in an initial step 1401, the main layer receives the marshalled GUI log text records from the GUI simulator, after which in a step 1402, the main layer discovers the GUI component object and the corresponding provider. Thereafter, in a step 1403, the main layer passes the marshalled GUI log text record together with the discovered GUI component to the corresponding provider. Subsequently, in a step 1404, the provider applies the event (ie the log text record) programmatically on the GUI component. The process 605 is then directed by an arrow 1405 back to the step 1401.

Accordingly, the process 605 in FIG. 14 loops through the steps 1401-1404 until the service support operator has completed remote operations on the application.

A number of benefits of the disclosed GLTR approach are clearly apparent. The disclosed method does not impose any requirements on integration with currently existing client applications, and does not require any code change other than code necessary for registering to the GUI logging service 405.

The GUI logging service 405 performs logging of GUI screens and events in form of GUI log text records, and thus network and the logging overheads are minimal. The GUI logging service 405 logs GUI screens in the form of GUI log text records and not images (apart from the images i.e. gif,jpg used in components i.e. icon, button).

As the logging is done in form of GUI log text records, the disclosed method enables programmatic analysis of client application use patterns, simplified accounting, and policy based support services. The client application user can be ensured of privacy of the data present in components (i.e JTextField) by not logging exact data (i.e text) present in the component or not displaying data to SSP at the time GUI reproduction/simulation is performed. It is noted that even in this case, the GUI simulator will show the component (i.e JTextField) but not show the data (ie text). In one advantageous arrangement, it can show “*”s or encrypted data instead of showing actual data (i.e. text) in component (i.e. JTextField).

The foregoing describes only some embodiments of the present invention, and modifications and/or changes can be made thereto without departing from the scope and spirit of the invention, the embodiments being illustrative and not restrictive.

1. A method of providing support for a client software application running on a first machine, said method comprising:
recording at said first machine Graphical User Interface displays and associated user actions as log text records;
invoking at a second machine support services dependent upon a support request relating to said running of said client software application on said first machine;
sending said log text records to said second machine;
simulating at said second machine said Graphical User Interface displays and said associated user actions from said log text records to create a simulation; and
providing said support using said simulation.

2. A method according to claim 1, further comprising:
processing by said second machine said log text records received from the first machine as simulated Graphical User Displays to create processed log text records;
sending said processed log text records representing actions taken on said simulated Graphical User Displays to said first machine;
remotely operating from said second machine said client software application running on said first machine using said processed log text records received by said second machine,
wherein said support is provided from said second machine by said remotely operating of said client software application running on said first machine.

3. A method according to claim 2, wherein said recording of said Graphical User Interface (GUI) displays and associated user actions comprises:
invoking at the first machine a GUI Logging service when said client software application is run;
detecting GUI events;
determining associated component hierarchies; and
recording GUI displays and associated user actions associated with said GUI events as said log text records.

4. A method according to claim 3, wherein said determining associated component hierarchies comprises:
determining if a component has been one of deleted and added; and
updating said associated component hierarchy accordingly.

5. A method according to claim 1, wherein said invoking of said support services at said second machine comprises:
determining if said support request is authorized;
invoking said support services if said support request is authorized; and
sending a message to said first machine if said support request is not authorized.

6. A method according to claim 3, wherein said detecting GUI events comprises:
discovering registered event listeners for application GUI components; and
registering associated event listeners, property change listeners, and component listeners.

7. A method according to claim 1, wherein said recording is dependent upon whether said detected GUI event is one of a property change, a user event, a component addition and a component removal.

8. A method according to claim 1, wherein said log record comprises a snapshot log text record that packs at least one of a plurality of events and a plurality of actions into a single log text record.

9. An apparatus for providing support for a client software application running on a first machine, said apparatus comprising:
a memory adapted to store a program; and
a processor adapted to execute said program, said program performing a method comprising:
recording at said first machine Graphical User Interface displays and associated user actions as log text records;
invoking at a second machine support services dependent upon a support request relating to said running of said client software application on said first machine;
sending said log text records to said second machine;
simulating at said second machine said Graphical User Interface displays and said associated user actions from said log text records to create a simulation; and
providing said support using said simulation.

10. An apparatus according to claim 9, further comprising:
processing by said second machine log text records received from said first machine;
sending said processed log text records representing actions taken on said simulated Graphical User Displays to the first machine;
remotely operating from said second machine said client software application running on said first machine using said processed log text records received by said second machine,
wherein said support is provided from said second machine by said remotely operating of said client software application running on said first machine.

11. An apparatus according to claim 10, wherein said recording of said first machine Graphical User Interface displays and associated user actions as log records comprises:
invoking at said first machine a GUI Logging service when said client software application is run;
detecting GUI events;
determining associated component hierarchies; and
recording GUI displays and associated user actions associated with said GUI events as said text-based log records.

12. An apparatus for providing support for a client software application running on a first machine, said apparatus comprising:
means for recording at said first machine Graphical User Interface displays and associated user actions as log text records;
means for invoking at a second machine support services dependent upon a support request relating to said running of said client software application on said first machine;
means for sending said log text records to said second machine;
means for simulating at said second machine said Graphical User Interface displays and said associated user actions from said log text records to create a simulation; and
means for providing said support using said simulation.

13. A computer readable medium having recorded a computer program for directing a processor to execute a method for providing support for a client software application running on a first machine, said method comprising:
recording at said first machine Graphical User Interface displays and associated user actions as log text records;
invoking at a second machine support services dependent upon a support request relating to said running of said client software application on said first machine;
sending said log text records to said second machine;
simulating at said second machine said Graphical User Interface displays and said associated user actions from said log text records to create a simulation; and
providing said support using said simulation.

14. A computer readable medium according to claim 13, wherein said method further comprises:
processing by said second machine log text records received from said first machine;
sending said processed log text records representing actions taken on said simulated Graphical User Displays to said first machine;
remotely operating from said second machine said client software application running on said first machine using said processed log text records received by said second machine,
wherein said support is provided from said second machine by said remotely operating of said client software application running on said first machine.

15. A computer readable medium according to claim 14, wherein said recording at said first machine Graphical User Interface displays and associated user actions as log text records comprises:
invoking at said first machine a GUI Logging service when said client software application is run;
detecting GUI events;
determining associated component hierarchies; and
recording GUI displays and associated user actions associated with said GUI events as said log text records.
